(19) United States
(12) Patent Application Publication
(10) Pub. No.: US 2014/0173389 A1
(43) Pub. Date: Jun. 19, 2014

(54) UPDATING SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/092,957

(22) Filed: Nov. 28, 2013

(30) Foreign Application Priority Data
Dec. 13, 2012 (CN) 201210536680X

(51) Int. Cl. G06F 11/10; G06F 9/445

(52) U.S. Cl. CPC G06F 11/1004; G06F 8/65
USPC 714/807

(57) ABSTRACT

An updating system for updating an electronic device, comprises a storage unit, an obtaining unit for obtaining an update data from a storage medium and a first check value corresponding to the update data, and storing the updating data to the storage unit, wherein the first check value is calculated according to the update data. A calculating unit for calculating a second check value according to the updating data stored in the storage unit. A determining unit for determining whether the second check value matches the first check value, and an updating unit for updating the electronic device according to the obtained update data when the second check value matches the first value. Thus, the updating system can avoid an error occurs during the updating process. An updating method applied in the updating system is also provided.

### BACKGROUND

1. Technical Field

The present disclosure relates to updating systems and method, and more particularly to an updating system and method capable of protecting an electronic device from update errors.

2. Description of Related Art

An electronic device, such as a portable DVD player, can be updated (e.g., firmware update) according to updating data stored in a storage medium, for example, a disk or a USB flash. However, if during the updating process an error occurs because of hardware issues or voltage instability, the electronic device may be unable to function thereafter.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an updating system in accordance with an embodiment.

FIG. 2 is a flowchart of an updating method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

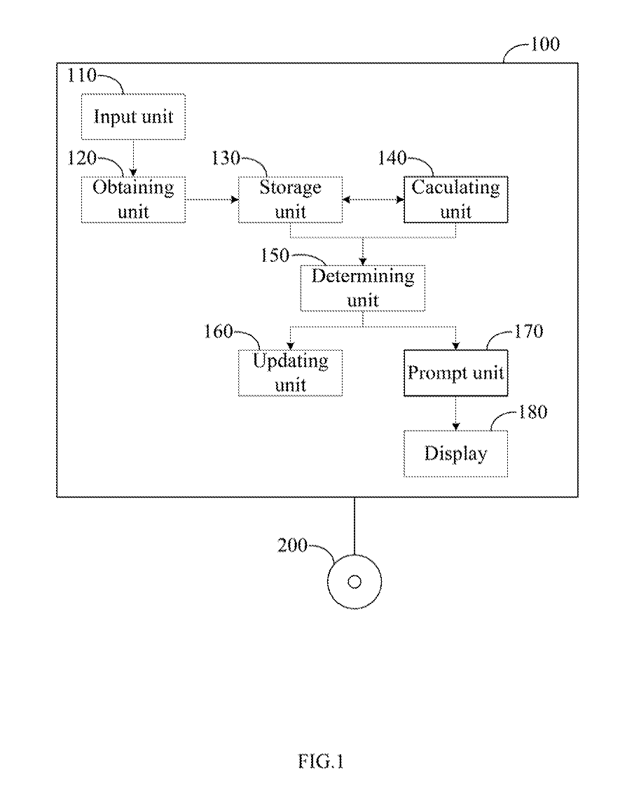

FIG. 1 shows a block diagram of an updating system 100 capable of updating an electronic device (not shown) in response to user operations. The updating system 100 obtains an updating data from an independent storage medium 200, and determines whether the copied updating data matches the updating data stored in the storage medium 200. If the copied updating data doesn't match the updating data in the independent storage medium 200, the updating system 100 does not update the electronic device, to protect the electronic device from malfunctioning. The storage medium 200 can be a disc, a USB flash disk, for example. The updating system 100 can be contained in a computer, a portable DVD player, or a set-top box. In this embodiment, the updating system 100 is contained in a portable DVD player, and the storage medium 200 is a disc.

The storage medium 200 stores the updating data and a first check value corresponding to the updating program. The first check value is obtained by calculation of the updating program according to a predetermined arithmetic calculation. In this embodiment, the first check value is the sum of all bytes of the updating data stored in the storage media 200.

The updating system 100 includes an input unit 110, an obtaining unit 120, a storage unit 130, a calculating unit 140, a determining unit 150, an updating unit 160, a prompt unit 170, and a display 180. The storage unit 130 can be SDRAM (Synchronous Dynamic Random Access Memory), or the like. The display 180 can be integrated with the updating system 100, or can be independent of the updating system 100.

The input unit 110 generates an updating signal for updating the electronic device in response to manual operations. The input unit 110 can be a keyboard having a plurality of keys and/or buttons, or a touch panel mounted on the updating system 100, and can also be a remote device for remotely controlling the updating system 100.

The obtaining unit 120 obtains the updating data and the first check value from the storage medium 200, and stores the copied updating data and the first check value to the storage unit 130 in response to the updating signal. In detail, the obtaining unit 120 stores the first check value in a special storage address of the storage unit 130, for example, the last four bytes.

The calculating unit 140 calculates a second check value by calculation of the updating data stored in the storage unit 130 according to the predetermined formula. In this embodiment, the second check value is the sum of all bytes of the updating data stored in the storage unit 130.

The determining unit 150 determines whether the second check value matches the first check value. In detail, the determining unit 150 obtains the first check value from the special storage address of the storage unit 130, and determines whether the second check value is equal to or corresponding to the first check value. In this embodiment, if the second check value is equal to the first check value, the determining unit 150 generates a first control signal; If the second check value is not equal to the second check value, the determining unit 150 generates a second control signal.

The updating unit 160 updates the electronic device according to the updating data stored in the storage unit 130 in response to the first control signal. In this embodiment, the updating unit 160 writes the updating data to the flash memory of the electronic device, for updating the electronic device.

The prompt unit 170 generates a warning message in response to the second instruction, for informing users that the updating data is wrong. The warning message can be an image or a number of characters displayed on the display 180. In another embodiment, the warning message may be an audio message output by a speaker (not shown).

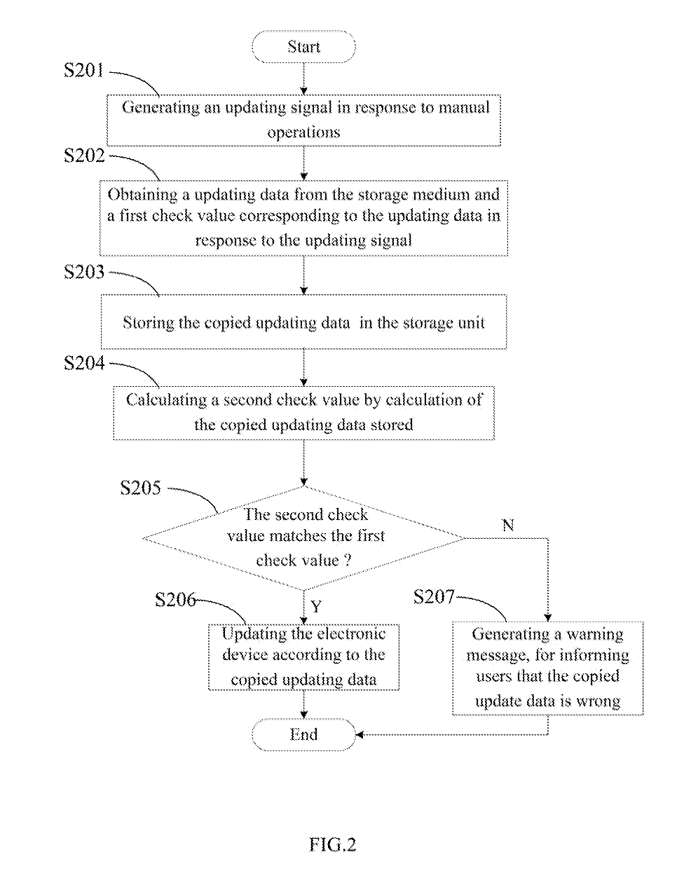

FIG. 2 shows that an updating method for updating the electronic device is provided. The method is applied in the updating system 100 capable of obtaining an updating data and a first check value from a storage medium 200, wherein the first check value is calculated according the updating data stored in the storage medium 200. The updating system 100 may be contained in a computer, a portable DVD player, or a set-top box. The method includes the following steps:

In step S201, the inputting unit 110 generates an updating signal for updating the electronic device in response to manual operations.

In step S202, the obtaining unit 120 obtains the updating data and the first check value from the storage medium 200 in response to the updating signal.

In step S203, the obtaining unit 120 stores the updating data and the first check value in the storage unit 130. In detail, the updating system 100 stores the first check value in a special storage address, for example, the last four bytes.

In step S204, the calculating unit 140 calculates a second check value by calculation of the copied updating data stored in the storage unit 130 according to the predetermined formula. In detail, the second check value is the sum of all bytes of the updating data stored in the storage unit 130.

In step S205, the determining unit 150 determines whether the second check value matches the first check value. In detail, the determining unit 150 obtains the first check value from the special storage address of the storage unit 130, and determines whether the second check value is equal to or corresponds to the first check value. In this embodiment, if the second check value is equal to the first check value, step S206 is implemented. If the second check value is not equal to the first check value, step S207 is implemented.

In step S206, the updating unit 160 updates the electronic device according to the copied updating data in the storage unit 130. In this embodiment, the updating unit 160 writes the updating data to the flash memory of the electronic device, for updating the electronic device.

In step S207, the prompt unit 170 generates a warning message, for informing users that the update program is wrong. The warning message can be an image or a number of characters displayed on the display 180. In another embodiment, the warning message may be an audio message outputted by a speaker (not shown).

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An updating system for updating an electronic device, comprising:
a storage unit;
an obtaining unit for obtaining updating data from a storage medium and a first check value corresponding to the updating data, and storing the copied updating data in the storage unit, wherein the first check value is calculated according to the updating data stored in the storage medium;
a calculating unit for calculating a second check value according to the copied updating data stored;
a judging unit for determining whether the second check value matches the first check value; and
an updating unit for updating the electronic device according to the copied updating data when the second check value matches the first check value.

2. The updating system according to claim 1, wherein the first check value and the second check value are calculated by using the same arithmetic formula.

3. The updating system according to claim 2, wherein the first check value is the sum of all bytes of the updating data stored in the storage medium, the second check value is the sum of all bytes of the updating data stored in the storage unit.

4. The updating system according to claim 1, further comprising a prompt unit, wherein the prompt unit for generating a warning message for informing users that the copied updating data is wrong when the second check value does not match the first check value.

5. The updating system according to claim 4, further comprising a display for displaying the warning message.

6. The updating system according to claim 1, further comprising an inputting unit for controlling the obtaining unit to obtain the updating data and the first check value in response to the users operation.

7. An updating method applied in an updating system for updating an electronic device, wherein the updating system comprising a storage unit, the method comprising:
obtaining updating data from a storage medium and a first check value corresponding to the updating data, wherein the first check value is calculated according to the updating data stored in the storage medium;
storing the copied updating date in the storage unit;
calculating a second check value according to the copied updating data;
determining whether the second check value matches the first check value; and
updating the electronic device according to the copied updating data when the second check value matches the first check value.

8. The updating method according to claim 7, wherein the first check value and the second check value are calculated by using the same arithmetic formula.

9. The updating method according to claim 8, wherein the first check value is the sum of all bytes of the updating data stored in the storage medium, the second check value is the sum of all bytes of the updating data stored in the storage unit.

10. The updating method according to claim 7, further comprising:
generating a warning message for informing users that the copied updating data is wrong when the second check value does not match the first check value.

11. The updating method according to claim 7, further comprising:
controlling the obtaining unit to obtain the updating data and the first check value in response to the users operation.
